(19) United States
(12) Patent Application Publication
(10) Pub. No.: US 2012/0120366 A1
(43) Pub. Date: May 17, 2012

(54) VISION MASK

(75) Inventors: Didier Clerc, Bellegarde Sur Valserine (FR); Didier Jacquemin, Morez (FR)

(73) Assignees: LOGO, Joinville Le Pont (FR); BNL EUROLENS, Bellegarde sur Valserine (FR)

(21) Appl. No.: 13/386,380

(22) PCT Filed: Jul. 19, 2010
(86) PCT No.: PCT/EP2010/060449

§ 371 Date: Jan. 20, 2012

(30) Foreign Application Priority Data
Jul. 21, 2009 (FR) 0903579

(51) Int. Cl. G02C 7/10

(52) U.S. Cl. 351/159.6

(57) ABSTRACT

The invention relates to a vision screen having a continuous convex surface (2) that is cylindrical, toroidal, or spherical, and that presents a trace in a binocular plane of sight that forms an outer circular arc of determined radius (R), the vision screen having a concave surface presenting a trace in the same plane of sight that forms, at least in a region around a point of intersection of each line of sight (AD, AG) with the concave surface, an inner circular arc (3, 4) having a specific radius of curvature (R1), and having a center (C1, C2) that is different from the center of the circular arc intersected by the other line of sight, wherein the radius (R1) specific to each inner circular arc is different from the radius (R) of the outer circular arc.

The present invention relates to a vision mask for use in certain activities such as driving at night or performing certain sporting practices in which visual acuity is of great importance.

### BACKGROUND OF THE INVENTION

Performing certain activities requires the line of sight to be provided with a screen for numerous reasons associated with accomplishing the activity under the best possible visual conditions.

In order to illustrate this concept, it is possible to take the example of driving a car at night, it being understood that this activity is not the only activity for which the invention finds an application.

It is known that at the end of the day, and a fortiori at night, the change in light transmission gives rise in most ametropic or emmetropic subjects to scotopic myopia, known as night myopia.

Furthermore, a large amount of work as shown that yellow filters, by selectively cutting off short wavelengths (i.e. blue light), improve contrast sensitivity and are sometimes recommended for night driving (see document FR 2 684 771).

Proposals have thus been made, e.g. in document FR 2 635 199, for corrective lenses having a power of 0.25 diopters negative that are tinted yellow (wavelength of 550 nanometers (nm), which lenses may optionally be subjected to certain additional treatments (anti-reflection, anti-scratching, . . . ) capable of improving the quality and/or the quantity of light that is transmitted. In order to satisfy as large a number of individuals as possible, a range of models may be provided, differing in the centering of the lenses (pupillary distance with possibilities for final adjustments by an optician), or in the shape of each lens.

For certain activities, a screen is provided that is in the form of a single optical component that covers both eyes without any gap, and in which no correction is performed. In general, such screens are thicker in the center than at their side extremities, so as to provide some correction for the prismatic deviation that is caused by any curved plate through which the line of sight is not normal to the faces of the plate. This extra thickness is obtained on manufacture by having the center of the concave surface offset along with the geometrical axis of the plate relative to the center of the convex surface of the plate, thereby giving the concave surface curvature that is greater than the curvature of the convex surface.

Finally, document U.S. Pat. No. 5,614,964 discloses a vision screen in accordance with the pre-characterizing portion of claim 1.

There exists a need for a screen capable of constituting a device for improving vision under certain circumstances of luminosity or for certain activities, i.e. that enables (positive or negative) vision correction to be provided.

### BRIEF SUMMARY OF THE INVENTION

The invention thus provides a vision screen having a continuous convex surface that is cylindrical, toroidal, or spherical, and that presents a trace in a binocular plane of sight that forms an outer circular arc of determined radius R, the vision screen having a concave surface presenting a trace in the same plane of sight that forms, at least in a region around a point of intersection of each line of sight with the concave surface, an inner circular arc having a specific radius R1 of curvature, and having a center that is different from the center of the circular arc intersected by the other line of sight. According to the invention, the radius specific to each inner circular arc is different from the radius of the outer circular arc. The specific radius of each inner circular arc may be less than or greater than the radius of the outer circular arc, depending on whether it is desired to obtain a power correction that is positive or negative.

The zone of the screen that is useful for each eye is thus treated in specific manner concerning both its ophthalmic correction and its prismatic deviation correction. By determining the radius of this concave surface portion of the screen that is intersected by the line of sight of each eye, and also by determining its center, it is possible firstly to give optical power to this zone, which power may be common (e.g. 0.25 diopters negative as mentioned above) or else personalized, taking account of the particular features of each eye (myopic, hypermetropic, astigmatic, . . . ), and secondly to correct the prismatic deviation (that necessarily exists because of the outer curvature of the screen, defined in terms of its base) in order to bring it into a range of values that are acceptable according to the standards that are in force, along the line of sight of each eye.

The screen may be made of any material that need not necessarily be adapted to optical correction. Advantageously, the screen is made of an injectable thermoplastic material such as, for example and in nonlimiting manner: polymethyl methacrylate, polycarbonate, polycarbonate and polyester blends, polyamide, polyester, copolymer of cyclic olefin, polyurethane, polysulfone, and mixtures thereof. It is also suitable for any coloring and for any functional coating. With a screen that is for night vision, the preferred coloring is yellow, as mentioned above. This coloring may be applied using traditional techniques, either by direct incorporation of dyes or pigments within the thermoplastic material during the injection step, or by post injection methods such as dip coating or centrifuging. Functional coatings may be deposited in the form of a single layer or multilayer film or varnish, by any deposition means such as, for example: dip coating, centrifuging, spraying, vacuum evaporation, or a jet of material delivered by the nozzles of an ink-jet print head. The coatings are advantageously selected from coatings presenting functions of the following types: anti-shock; anti-abrasion; anti-reflection; anti-dirtying; anti-misting; anti-static; polarizing; coloring; and photo-chromic.

In a preferred embodiment, the inner circular arcs have the same specific radius. Alternatively, the inner circular arcs have specific radii that are different.

Preferably, the screen presents two zones of minimum thickness that are spaced apart from each other in the plane of sight by a distance that is equal to the pupillary distance.

Each of the concave surfaces is cylindrical, spherical, or toroidal, depending on the desired appearance and on the desired optical effect. As is well known, cylindrical surfaces do not present the same correction characteristics about a point of intersection of each line of sight with the concave surface as are presented by surfaces that are spherical or toroidal.

For reasons of appearance, of fitting to a frame, and of attractiveness of the screen, the concave surface may include peripheral regions that are peripheral relative to the region around a point of intersection between a line of sight with the concave surface, the peripheral regions having surfaces defined by centers and by curvatures that are different from those of the surface of the central region they surround. It is thus possible to choose to thin down the edges of the screen or its central portion by varying these surfaces for which optical imperatives are not of the greatest importance.

Other characteristics and advantages of the invention appear from the description given below of an embodiment of the invention.

### BRIEF DESCRIPTION OF THE DRAWING

Reference is made to the accompanying drawing, in which:

FIG. 1 is a section view of a screen in accordance with the invention on a horizontal section plane containing both vision axes;

FIG. 2 is a section view of the screen on a vertical plane containing one vision axis; and

FIG. 3 is a view like that of FIG. 1, showing a screen in accordance with the invention in which the ophthalmic correction is stronger than that shown in FIG. 1 (0.50 instead of 0.25 negative diopters).

### DETAILED DESCRIPTION OF THE INVENTION

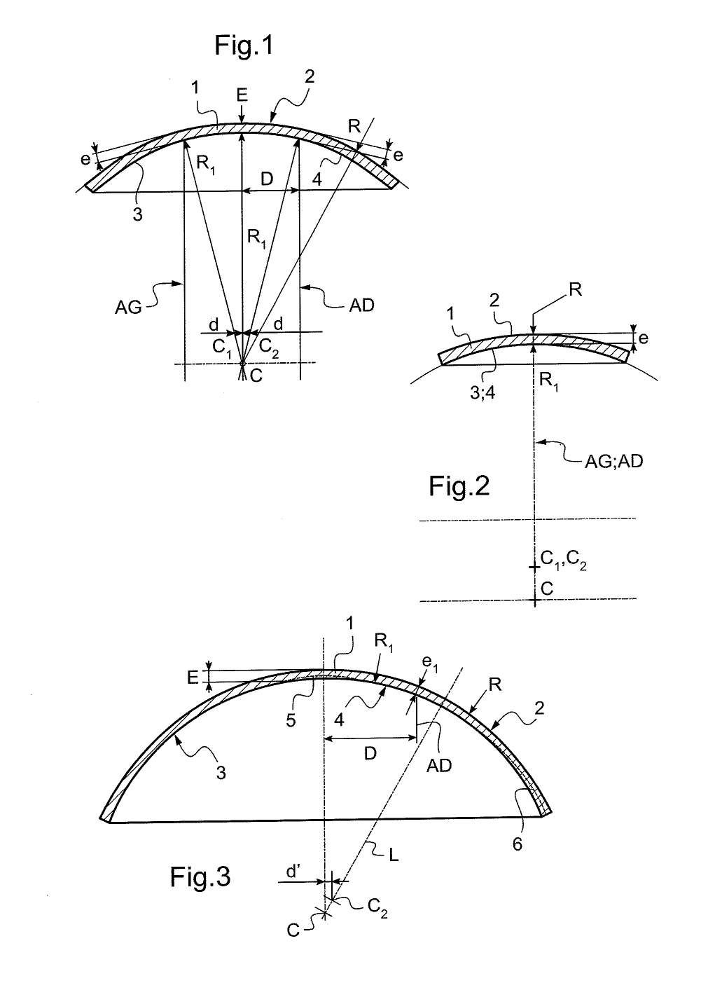

With reference to FIGS. 1 and 2, the screen shown is a plate 1 made of any material that is suitable for constituting a corrective lens (in particular of polycarbonate).

The plate has a convex surface 2 and a concave surface 3. As shown in the figures, the convex surface is a continuous spherical surface 2 of center C and of radius R. The concave surface is more complex. Still as shown in FIGS. 1 and 2, it comprises two spherical surfaces 3 and 4 that are defined as follows:

in this configuration, their respective centers C1 and C2 are situated on the line joining the center C of the convex surface to the point where the line of sight AG or AD of each eye of the wearer intersects the concave surface. It is known that on average the line of sight is offset from the vertical plane of symmetry of a wearer by about 32 mm (distance D or pupillary distance equal to 2D). Thus, the smallest thickness e of each portion of the screen concerned by an eye lies on the line of sight AD, AG of that eye;

the specific radius of curvature R1 of each of them is such that the (negative) optical power of the lens is of the order of −0.25 diopters;

the thickness of the center E of the screen corresponds to the distance between the intersection of the spheres 3 and 4 and the sphere 2 in the plane of sight defined by AG and AD.

In the specific example of FIGS. 1 and 2, for a polycarbonate screen, the value of R is 87.17 millimeters (mm) (which corresponds to a base 6 in the field of eyeglasses, i.e. the radius in the plane of sight of the lens, in meters, is the ratio of the base divided by the index of refraction minus one), and the value of R1 is 82.96 mm. The distance d between each center C1 and C2 from the vertical midplane of the mask is 1.24 mm, the axes AD and AG being at a distance D=32 mm from this plane, and the value E of the thickness of the screen is 2.50 mm. The minimum thickness e is here both on the line of the centers C and C1 or C2, and on the optical axis AD, AG, and it is equal to 2.15 mm.

The surfaces in question are all spherical, and the ophthalmic correction is 0.25 diopters negative, whereas the correction of the total diverging prismatic deviation (that of both lenses) lies in the range 0.7 mm to 1 meter (m).

In these figures, the two concave surfaces of radius R1 and of centers C1 and C2 cover the entire (concave) rear face of the screen. As can be seen in FIG. 3, these surfaces of radius R1 and of centers C1 and C2 may be limited to zones that are close to the line of sight of each eye, the remainder of the rear face of the screen presenting surface portions that are different in order to satisfy other requirements for the screen, e.g. in terms of appearance.

The screen may have a convex surface that is cylindrical and concave surfaces such as 3 and 4 that are either spherical or cylindrical. With cylindrical surfaces, the correction of prismatic deviation takes place only in a horizontal direction, whereas spherical services also provide a correction for prismatic deviation in the vertical plane.

It is also possible to marry a toroidal convex surface with concave surfaces that are likewise toroidal or else spherical, in order to obtain the ophthalmic and deviation corrections that are better adapted to the wearer.

It comes within the scope of the invention to make provision for one concave surface 3, e.g. a spherical surface, to be of radius and of center such that the power of the screen facing the left eye differs from the power facing the right eye.

Although the above description relates to correction using negative power, the invention also applies to positive corrections (R1 would then be greater than R), and indeed to corrections that are more specific, such as astigmatism.

FIG. 3 shows a screen of the invention in which the ophthalmologic correction power is 0.50 diopters, negative. It can be seen that the various parameters identified in this figure using the same references as in FIG. 1 are substantially different between the two situations, for constant R corresponding to a screen of base 6 made of the same material. These values are as follows (in millimeters):

R=87.17

R1=79.78

E=3

e1=2.37, which is not the minimum value of the thickness of the screen, which is to be found on the line of centers L, and

d=2.43.

In this FIG. 3, dashed lines 5 and 6 show the traces of concave surfaces that are not identical to the surface 4 in order to illustrate the fact that the surface 4 may be limited to a region surrounding the line of sight AD or AG and may be surrounded by peripheral surface portions making it possible, for example, to narrow the edge and the center of the screen.

What is claimed is:

1. A vision screen having a continuous convex surface (2) that is cylindrical, toroidal, or spherical, and that presents a trace in a binocular plane of sight that forms an outer circular arc of determined radius (R), the vision screen having a concave surface presenting a trace in the same plane of sight that forms, at least in a region around a point of intersection of each line of sight (AD, AG) with the concave surface, an inner circular arc (3, 4) having a specific radius of curvature (R1), and having a center (C1, C2) that is different from the center of the circular arc intersected by the other line of sight, wherein the radius (R1) specific to each inner circular arc is different from the radius (R) of the outer circular arc.

2. A screen according to claim 1, wherein the inner circular arcs have specific radii of curvature (R1) that are the same.

3. A screen according to claim 1, wherein the inner circular arcs have specific radii of curvature that are different.

4. A screen according to claim 1, wherein the specific radius of curvature (R1) of each inner circular arc is smaller than the radius (R) of the outer circular arc.

5. A screen according to claim 1, wherein the specific radius of curvature (R1) of each inner circular arc is greater than the radius (R) of the outer circular arc.

6. A screen according to claim 1, wherein the concave surface is, at least in the region around each point of intersection, cylindrical, spherical, or toroidal.

7. A screen according to claim 1, wherein the concave surface (4) includes peripheral regions (5, 6) that are peripheral relative to the region around a point of intersection between a line of sight with the concave surface, the peripheral regions having surfaces defined by centers and by curvatures that are different from those of the surface of the central region they surround.
